(19) United States
(12) Patent Application Publication
(10) Pub. No.: US 2022/0215307 A1
(43) Pub. Date: Jul. 7, 2022

(54) METHOD AND APPARATUS FOR GENERATING SAFETY INFORMATION USING PROGRESS SCHEDULE

(71) Applicant: Kyeongok YANG, Seoul (KR)

(72) Inventor: Kyeongok YANG, Seoul (KR)

(21) Appl. No.: 17/602,461

(22) PCT Filed: Apr. 10, 2019
(86) PCT No.: PCT/KR2019/004310

§ 371 Date: Oct. 8, 2021

(51) Int. Cl. G06Q 10/06; G06Q 50/08; G06F 16/901

(52) U.S. Cl. CPC G06Q 10/0635; G06F 16/9024; G06Q 50/08

(57) ABSTRACT

A safety information generation method using a schedule bar chart according to the present invention includes: a first step of setting a safety standard by stipulating items that may cause disasters and determining a relationship with parallel, preceding, and subsequent activities; a second step of preparing a schedule bar chart while construction is processing by each partner company; a third step of analyzing contents of the schedule bar chart by a control unit; a fourth step of evaluating the risk for each activity by the control unit by determining whether the contents of the schedule bar chart of the second or third step exceeds the safety standard of the first step and; a fifth step of determining that there is a risk when the safety standard is exceeded as a result of comparing the steps.

### TECHNICAL FIELD

The present invention is provided to prevent safety disasters occurring during construction on construction and industrial construction sites, and more specifically, relates to taking measures in advance by analyzing risks by a control unit by using information in schedule bar charts prepared by a number of partner companies in activity types of temporal installation, civil engineering, construction, electricity, and equipment, in a case where a preceding activity is not completed or a subsequent activity does not follow the preceding activity, or in a case where dangerous activities are concurrently performed in the same space.

### BACKGROUND

For industrial accidents, the number of fatalities per 100,000 people was 3.0 in OECD and 7.0 in Korea, which is twice that of the OECD (reported on Aug. 28, 2017 in the daily newspaper of Jungang Ilbo in Korea).

According to an industrial accident occurrence status in 2016 announced by the Ministry of Employment and Labor in Korea, the total number of industrial accidents was 90,656, which means that more than 10 disaster victims occur per hour. Among them, the number of construction disaster victims is accounted for 29.3% of those in all industries. The total number of fatal disaster victims is 1,777, with more than one fatality occurring every 5 hours, and the number of fatalities in construction is 31.2% of those in all industries.

In 2016, the number of fatal disaster victims in all industries was 969, among them, the number of fatal disaster victims in the construction industry was 499, that is, 51.5% of all industries (reported on May 25, 2017 in the daily newspaper of Construction Economy in Korea).

With the development of construction technology, the construction of high-rise buildings and high-rise apartment buildings that rise high into the sky has increased, and the construction of digging deep underground is increasing along with large shopping malls and large-scale factory complexes spreading horizontally.

As a result, up to thousands of workers per day are distributed vertically and horizontally in many spaces, and the activities of dozens or hundreds of temporal installation, construction, electricity, and equipment are complicatedly processed with each other.

While safety objects of to be managed becomes vast and complex, the traditional method of safety management by manpower is maintained.

For example, in a case where the manager lacks construction experience and in a case where there is a safety problem in a specific space but the problem is not recognized, safety management centered on manpower means that misunderstanding occurs, safety facilities are dismantled or moved without permission, communication between activity types of the preceding activity and the subsequent activity is not successful, the worker enters a prohibited area erroneously, the worker does not properly equip with safety facilities, and the like.

The following is a contribution from a safety expert.

As any safety-related expert knows, there is a principle of cause connection among the four principles of disasters. All disasters have a cause. The most unfortunate of all construction accidents is that no matter how much the injured person complies with the safety activity procedures, the accident can occur if the wrong activity conditions are prepared in the preceding process. Such examples occur in most cases of construction accidents (reported on May 25, 2017 in the daily newspaper of Construction Economy in Korea).

It is determined that the conventional safety management method as described above has a part that cannot manage vast and complex activities or safety facilities, equipment, and workers based on limited manpower and experience.

As documents related to safety management, there are a risk evaluation report, a hazard prevention plan report, a night activity permit report, an activity report, and the like. First, in the case of the risk evaluation, the process is as follows.

In the early stage of construction, when preparing the hazard prevention plan report, a safety management plan report, or a construction plan report, an initial risk evaluation is carried out, the risk evaluation report is prepared in consideration of the on-site situation before the relevant activity, and the activity from material import to construction material export is divided into detailed units, and a schedule bar chart is prepared.

If a unit activity is classified, risk factors (human factors, mechanical factors, electrical factors, material factors, activity characteristic factors, activity environment factors, and the like) are identified for the activity. Safety measures that can be taken on-site for identified risk factors are established and risks review by a preparer, a construction manager, and a safety manager are determined.

A risk evaluation meeting (preparation partner company, construction and safety staffs, and site manager attending) is conducted by collecting the data the week before the start of the relevant activity type. It determines when and who take and confirm the safety measures for the selected risk factors, and conducts delivery training until the day before the activity is carried out.

On the other hand, the risk evaluation report is important and evaluates a part of the overall activities focusing on the activity with a high risk level, and the evaluation contents are being prepared according to the individual capabilities of the partner company.

Therefore, there are some activities that have not been evaluated because the risk evaluation does not cover the entire activities. In particular, since many activities are carried out simultaneously during the finishing construction period such as interior, it takes a lot of time and effort to prepare the risk evaluation and an evaluation meeting, so only a major activity has to be selected and managed. In addition, the content of the evaluation is highly subjective depending on the competency of a creator of the partner company.

On the other hand, in the schedule bar chart, time and date are indicated on the X-axis and the activity contents are displayed in the bar chart or Gantt chart of a bar shape. Accordingly, there is an advantage of being able to visually easily grasp when an activity starts and when the activity ends.

However, in the schedule bar chart, the bar display indicates when the activity is processing, but any information about safety does not contain therein. Safety management and the schedule bar chart are being used separately for different purposes.

### SUMMARY OF INVENTION

### Technical Problem

In the present invention, a process plan is established for all activities on the site and a causal relationship between some activities are comprehensively analyzed in a time series. Objective and systematic safety standards verified by a number of experts are established and whether a process plan exceeds the safety standard is analyzed.

### Solution to Problem

In order to solve the above-described technical problems, the present invention evaluates the risk of equipment, a temporary material, or the like necessary for a partner company to perform the activity.

What other dangerous activities are in the same workspace is defined.

By analyzing an influence of the preceding activity and an influence of the subsequent activity, what state of the preceding activity and the subsequent activity should be is comprehensively analyzed in time series to ensure that the current activity is safe.

In order to determine whether a specific activity is dangerous, risk evaluation standards are established through objective data standards, laws, regulations, cases, expert opinions, or the like. The risk evaluation standards include standards (height, strength, size, installation time, retention period, and dismantling time) for safety facilities, standards (work conditions for construction, temporal installation, electricity, equipment such as temperature, humidity, wind, toxic gas, lighting, electric shock, and pressure) for activity conditions, a schedule difference (condition that the preceding activity must be completed) of the preceding activity, and a schedule difference (condition that the subsequent activity must follow) with the subsequent activity. These data are classified by construction type, operation type, and activity type, and made into a DB.

A method of collecting activity information utilizes a master (total) schedule bar chart, a monthly schedule bar chart, and a weekly schedule bar chart, which have been conventionally done without additional effort or system manpower.

The risk evaluation is carried out by comprehensively determining contents analyzed from the schedule bar chart by the control unit and how dangerous the environment surrounding the activity set in a safety standard setting step.

### Advantageous Effects

According to the present invention, the following effects can be expected.

In the prior art, the risk was evaluated only for a high risk or major activity, but according to the present invention, the risk can be evaluated for all or most activities.

In addition to the existing safety management activities, it is possible to analyze risks systematically and immediately by simply preparing the schedule bar chart that has been done in the past without inputting additional manpower, effort, time, policy, and system.

In the past, the risk evaluation was strongly subjective in that the content differed depending on the individual evaluator's competency. However, according to the present invention, since objective and systematic safety standards such as opinions of expert groups, laws, regulations, safety standards, and cases are prepared in advance, the risk evaluation is refined.

In the past, it was difficult to analyze the preceding activity or the subsequent activity that made the specific activity dangerous, and even in a case of being analyzed, it took a lot of time and effort by the analyst manually analyzing it, and the content was also very subjective. According to the present invention, it is possible to accurately grasp how the preceding activity or the subsequent activity related to the specific activity will affect the current activity status. Accordingly, it is possible to systematically analyze not only the problem of the specific activity itself, but also a relationship with the external environment (different activity type, preceding activity, subsequent activity, upper, lower, left and right activities) surrounding the specific activity.

In the past, the schedule bar chart prepared by each partner company was used to grasp how much the activity is progressing, whether the activity is late or early compared to the plan, and the speed of construction. According to the present invention, it is possible to analyze the safety-related influence of the activity on the schedule bar chart.

### BRIEF DESCRIPTION OF THE DRAWINGS

FIG. 1 is a block diagram illustrating a configuration of a safety information server 20 provided by generating safety information by using a schedule bar chart according to an embodiment of the present invention and a terminal 10.

FIG. 2 is a configuration diagram of a safety information generation apparatus using the schedule bar chart according to an embodiment of the present invention.

FIG. 3 is a conventional schedule bar chart format.

FIG. 4 is a flowchart illustrating a safety information business process between a construction company, which generates and provides safety information using the schedule bar chart according to each embodiment of the present invention, and a partner company.

FIG. 5 is an example of setting safety standards for a specific activity according to the present invention.

FIG. 6 is an example illustrating a schedule bar chart of cooperation to perform an insulation activity according to the present invention.

FIG. 7 is an example illustrating a schedule bar chart prepared by a partner company performing a fire resistant coating activity according to the present invention.

FIG. 8 is an example illustrating a schedule bar chart prepared by a partner company performing a fire extinguishing piping activity according to the present invention.

FIG. 9 is an example in which the schedule bar charts prepared in FIGS. 6, 7 and 8 are integrated and displayed.

FIG. 10 is an example illustrating a result of risk evaluation by analyzing the integrated schedule bar chart of FIG. 9.

### BEST MODE FOR INVENTION

Hereinafter, an apparatus and method for safety information generation using a schedule bar chart according to the present invention will be described in detail.

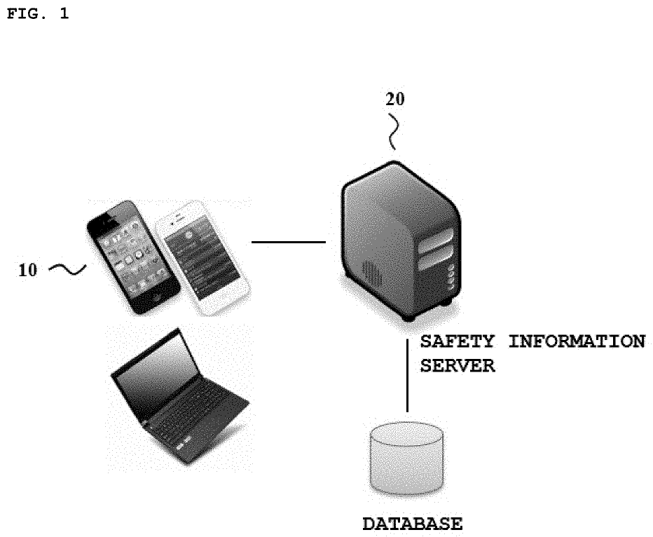

FIG. 1 is a block diagram illustrating a configuration of a safety information server 20 that generates and provides safety information using the schedule bar chart according to an embodiment of the present invention and a terminal 10.

Referring to FIG. 1, the safety information server 20 using the schedule bar chart according to the present embodiment is responsible for receiving and determining safety information, and providing the safety information to the terminal 10. The terminal 10 is responsible for inputting and inquiring the schedule bar chart or the safety information.

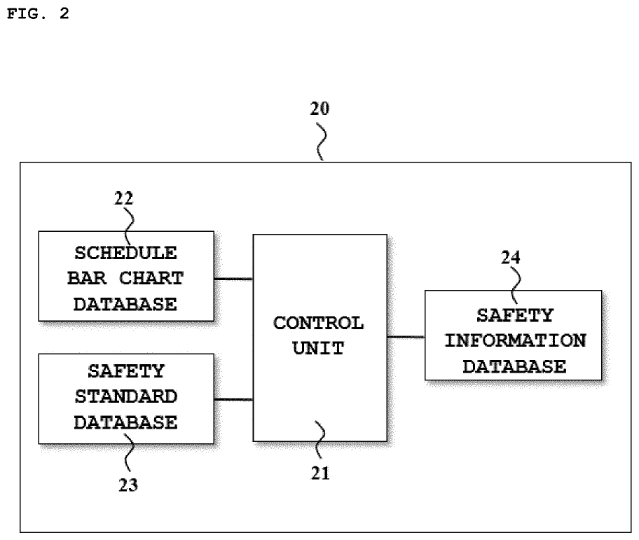

FIG. 2 illustrates a configuration of a safety information generation apparatus using the schedule bar chart according to an embodiment of the present invention.

Referring to FIG. 2, the functional configuration of the safety information server 20 according to the present embodiment includes a control unit 21, a schedule bar chart database 22, a safety standard database 23, and a safety information database 24.

The control unit 21 stores the schedule bar chart in the schedule bar chart database 22 and stores a safety-related standard in the safety standard database 23. In addition, after reading activity contents from the schedule bar chart database 22 and evaluating the risk, result data is stored in the safety information database 24. In addition, the control unit 21 is responsible for transmitting the contents of the database to the terminal 10 according to the user's request.

Additionally, the control unit 21 may prepare countermeasure information such as a risk-related measure method, a procedure book, a law, a regulation, and the like. The countermeasure information may be prepared in advance in the safety standard database 22 to be utilized.

The control unit 21 may display a degree of risk for each step, level, and grade for the activity exceeding the safety standard. It may display the size and influence of the disaster expected on the site by being sorted in order of magnitude.

The schedule bar chart database 22 stores the schedule bar chart prepared by the partner company for each professional activity type in the fields of temporal installation, civil engineering, construction, electricity, equipment, environment, and plant. The schedule bar chart is prepared with Primavera (P6), MS-Project, or Excel, which is a schedule bar chart preparation program.

The safety standard database 23 stores safety standards for a specific activity. For example, the activity name is cleaning a septic tank, and the safety standards and rules are measuring the concentration of oxygen and harmful gas, performing ventilation, and wearing an air respirator or oxygen mask.

When the concentration of hydrogen sulfide reaches 20 to 30 ppm, the olfactory nerve cells become fatigued, and when it exceeds 700 ppm, the oxidative capacity in the blood is exceeded and neurotoxic action occurs by attacking the nerve cells.

The safety standard database 23 also stores conditions of the preceding activity or conditions of the subsequent activity for the specific activity. For example, it is important whether the valve is closed in the preceding activity in the activity of the equipment activity type. This is because, if the valve is temporarily opened and is not closed, an explosion or pipe bursting may occur when performing the subsequent activity type.

As conditions for the subsequent activity, in a case where the specific activity is to spray a material with high fire risk as an insulation material, the fire resistance material coating activity surrounding the painting material must be immediately followed. If the subsequent activity is not undertaken or followed late, the insulation material painting is greatly exposed, thereby increasing the fire risk. A range of a difference between spraying the insulation material that is the current activity and the fire resistance material painting that is the subsequent activity, or a difference in the progress rate is set. Since such a difference may vary depending on the number of floors, an area, or the like, it is preferable to set the range in consideration of the site characteristics.

The safety standard database 23 is prepared for each activity type. Each activity type includes civil engineering, construction, electricity, equipment, environment, plant, and the like, and a name and code are assigned according to the activity breakdown structure. The activity name may be written and saved in the language of each country, such as Korean, English, Japanese, Chinese, Indian, or Spanish.

The safety standards are stored on the server of the construction company's headquarter. The safety standards can be downloaded from the safety standard database 23 server of the construction company headquarter to the server of each site to be used. The manager of the construction company or each specialized construction company can modify and use the safety standards according to the characteristics of the site, and create new standards on the site. New safety standards can be registered on the company headquarter server. As time goes by, safety standard data is continuously accumulated according to a systematic classification system. As a result, safety standards in previous construction projects are vast and most safety standards can be applied to new construction projects.

The safety standard database 23 may also include objective and official standards such as various specifications and laws. The laws and the like are sent to the control unit 21, and the control unit 21 is used to determine whether the activity situation exceeds the standards of the laws and the like.

The safety standard database 23 may also include safety disasters and accident cases. Past safety disasters are classified by including information such as the construction pattern and the activity type so that they can be matched with on-site activity.

The safety standard database 23 can be shared by being supplied to national institutions, research institutes, other construction companies, and even other countries after being stored on the server by a specific construction company.

The safety information database 24 stores risk evaluation information analyzed by the control unit 21. For example, the control unit 21 determines from the safety information database 24 that the activity A is currently spraying insulation material on the ceiling of the fourth basement floor and spraying 75% of the total area. In addition, the control unit 21 reads from the safety standard database 22 whether there is a preceding activity condition or a subsequent activity condition. As the subsequent activity condition, the fire resistance material painting activity (activity B) must be started within 2 days from the start date of the activity A.

Alternatively, if the difference between the progress rates of the activity A and the activity B exceeds 30%, the fire risk is determined to be medium, and if it exceeds 60%, the fire risk is determined to be very high. In addition, if it is determined whether there is electric welding or a gas welding activity on the same floor or room, it is evaluated that the fire risk is high. The analysis result as described above is stored in the safety information database 23.

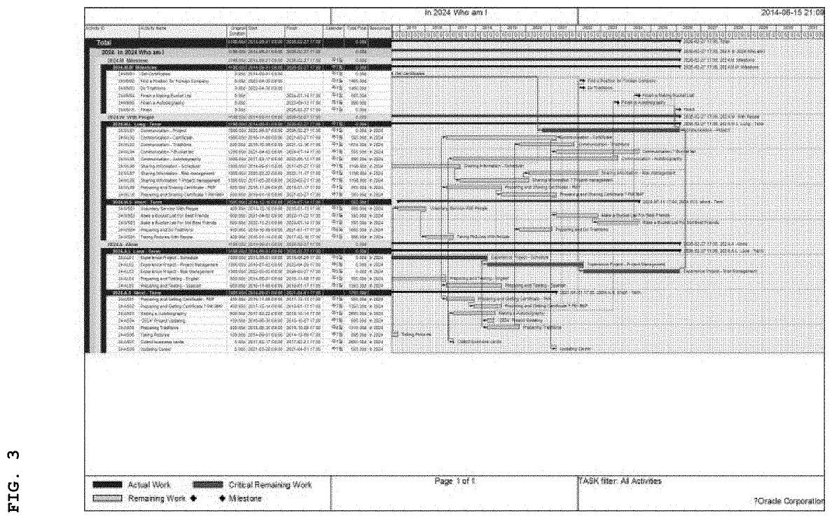

FIG. 3 is an example of a conventional schedule bar chart. It is a schedule bar chart prepared with Primavera that is a representative of the schedule bar chart preparing programs.

The schedule bar chart is prepared including the activity name (position), the number of activity days, the start date, the completion date, the progress rate, and the activity precedence relationship. The schedule bar chart is a chart that contains and displays a lot of information that can be known not only about a person's information, but also about the surrounding environment, such as displaying birth, death, age, father, descendant, and relatives, like a person.

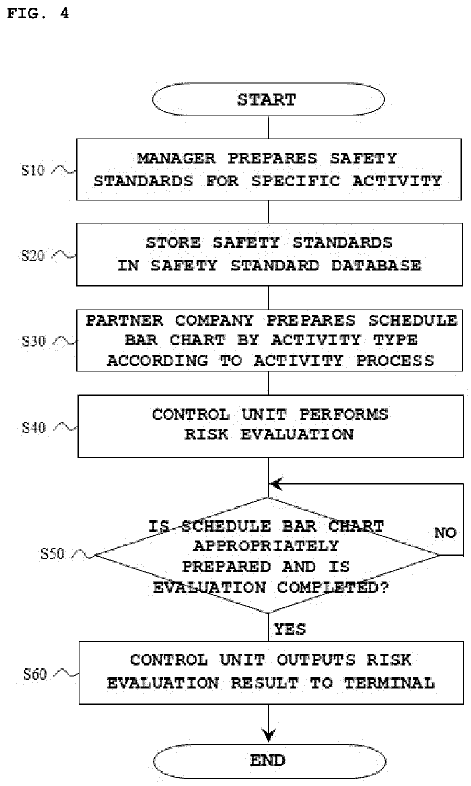

FIG. 4 is a flowchart illustrating a safety information business process between a construction company and a partner company for providing by generating safety information using the schedule bar chart according to each embodiment of the present invention.

First, referring to FIG. 4 according to an embodiment, the construction company and the partner company prepare safety standards for the specific activity (S10).

For example, the safety standards and rules for cleaning the septic tank include measuring the concentration of oxygen and harmful gas, performing ventilation, and wearing an air respirator or an oxygen mask.

In a case of electrical equipment, the order of the activity is established and the condition is set in which the subsequent activity should not be started if the preceding activity is not completed or the current status is in any situation. In a case of electrical room construction, the standard is that no activity can be performed while electricity is on. In a case of construction, the condition is that the activity cannot be started unless safety facilities are identified.

When the safety standards are prepared, they are systematically stored in the safety standard database 23 (S20). The safety standards are saved by using an activity breakdown system suitable for on-site construction characteristics, and the construction type codes of civil engineering, construction, electricity, and equipment are used.

Now, when the construction starts, the partner company prepares the schedule bar chart (S30). For example, when the vertical plumbing of the machine room on the fourth basement floor is started in facility construction, the activity contents are displayed on the schedule bar chart. Personnel or equipment safety-related items may also be included. There are two types of schedule bar charts, that is, a master schedule bar chart in which the entire construction period is written and a weekly schedule bar chart that is written on a weekly basis. Since the weekly schedule bar chart is detailed and accurate, the weekly schedule bar chart is determined to be more effective for the risk evaluation of the activity.

When the schedule bar chart is prepared, the risk is evaluated in the next step (S40). The control unit 21 reads the activity information from the schedule bar chart. In addition, the safety standards related to the specific activity are read from the safety standard database 23. Then, the activity information and the safety standards are compared. As a result of comparison, it is quantitatively determined that there is a risk if the safety standards are exceeded. The determination result is systematically stored in the safety information database 24.

For example, if there is the welding activity in a space where the insulation material spraying is performed, the control unit determines that the insulation material spraying is not safe because the insulation material spraying can cause a fire. In addition, by comparing the start date or the progress rate of the insulation material spraying with the progress rate of the fire resistance material painting activity, which is a subsequent activity condition, it is evaluated that there is a risk if it deviates from the standards. In a case of equipment, if there is a pipe barometric pressure test for a specific line today, check is performed whether water vapor was discharged the previous day. If water vapor in the pipe is not discharged, it is determined that an explosion may occur during the barometric pressure test.

In a case of electricity, if there is electricity in the electrical room, a risk of electric shock occurs when the water-related activity starts, so the electricity must be cut off. In addition, it is determined whether there is any water-related activity in the upper floor of the electrical room, and whether water can enter the electrical room on the lower floor when water leak occurs.

In this way, the control unit 21 analyzes the preparation, facility, and equipment of the activity itself for performing the relevant activity with respect to the specific activity. In addition, it comprehensively determines the risks of the preceding activity and the subsequent activity conditions, the activity process, and all activities generated in the upper, lower, left, and right spaces surrounding the specific activity. In addition, the control unit 21 comprehensively evaluates the mutual influence and risk between all activities for all activities on the site with reference to the standards set in the safety standard 23.

As a result of the determination of the control unit 21, if there is no necessary information in a case where the activity contents are omitted or difficult to read in the contents of the schedule bar chart, a query is prepared. When the manager of the partner company or the construction company confirms the contents and corrects the schedule bar chart 22 or writes an answer to the query, the control unit 21 performs the risk evaluation (S40) again with reference to the answer (S50).

Next, when the risk evaluation (S40 and S50) is completed, the control unit 21 stores the evaluation result in the safety information database 24 and outputs that the evaluation is completed to the terminal 10 (S60).

For example, a prime construction company who oversees all partner companies can view all safety information 24. The waterproofing partner company inquires about the risk evaluation of the waterproofing construction through a PC or smartphone.

Additionally, the control unit 21 may prepare countermeasure information such as a risk-related measuring method, a procedure book, law, regulation, and the like. The countermeasure information may be prepared in advance in the safety standard database 23 to be utilized.

After confirming the contents in the step of confirming the risk (S60), the construction company or the worker of the partner company takes necessary safety measures, and then inputs the result of the measures into the safety information database 24.

### MODES FOR CARRYING OUT THE INVENTION

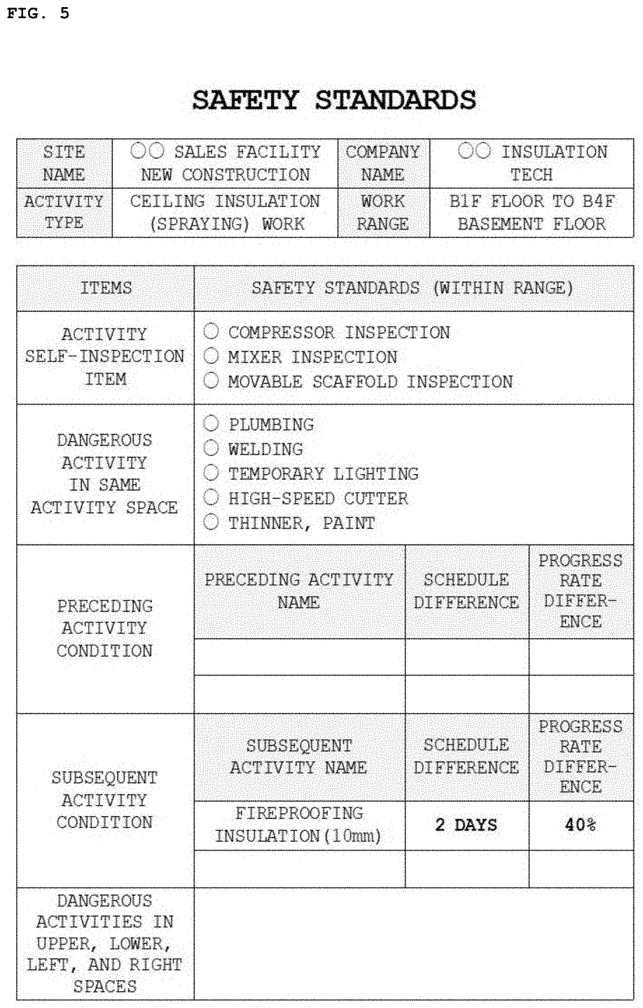

The following illustrates embodiments of the specific activity of a construction site according to the present invention in FIGS. 5 to 10.

FIG. 5 is an example of setting safety standards for specific activity according to the present invention.

Referring to FIG. 5, it is a process of constructing polyurethane foam on the ceiling for insulation of the basement floors, the floors are from the fourth basement floor to the first basement floor, and the partner company is oo company.

First, the first column illustrates the safety standard items newly proposed in the present invention. In the second column, the safety standards are established.

First of all, the activity self-inspection item that is the first item in the first column is the safety standard that the oo company must follows during the construction of polyurethane foam which is an insulation material. It is necessary to inspect the equipment and the temporary scaffold for the construction of polyurethane foam.

The second is a dangerous activity in the same activity space, and it establishes that it may not be safe by working with other construction types within the floor and space where polyurethane foam is constructed. For example, if the words or meanings of plumbing, welding, temporary lighting, high-speed cutter, thinner, or paint are carried out together in the same space by another partner company, a fire may occur. This is because polyurethane foam sprayed on the ceiling is weak against fire and can burn, and it can cause serious disasters by spewing poisonous gas.

The third item is the preceding activity condition in which the preceding activity may be indicated for the construction of the current activity. For example, if the activity which is currently being performed is masonry for an exterior wall, an exterior scaffold must be installed.

The fourth item is the condition for the subsequent activity, which establishes what kind of state of the subsequent activity or relationship with the current activity should be for the construction of the current activity. As illustrated, since polyurethane foam is weak against fire, it is necessary to prevent a fire by spraying fire resistant coating on the polyurethane foam as a subsequent process after the polyurethane foam is constructed on the ceiling.

However, even though the polyurethane foam is constructed on the ceiling, if the fire resistant coating, which is a protective material, is not sprayed or the following speed is slow, the risk of fire due to flame increases. The schedule difference is the standard for how many days difference between the polyurethane foam and the fire resistant coating should be.

Since the range of the polyurethane foam spraying is not large for 1 to 2 days, damage is limited even in case of fire. However, if there is a difference of 3 days or more, or if two progress rates differ by more than 40%, the area of the polyurethane foam exposed from the fire resistant coating increases, thereby increasing the risk of fire and damage.

Since the difference in schedule and the difference in the progress rate described above are newly proposed according to the present invention, it is preferable that the standards are determined by those involved in the construction in consideration of the construction space and the area to be sprayed.

The fifth item is dangerous activities in the upper, lower, left, and right spaces and in which for the current activity, the type of activity that becomes a dangerous situation when being constructed next to the upper floor or lower floor is selected and described. For example, if water enters the electrical room on the lower floor by carrying out the activity that can cause falling disasters and water spilling due to upper and lower simultaneous activities, an electric shock accident may occur caused by high-voltage electricity.

As described above, the prior art is focused on an unsafe activity in the same space, but the present invention emphasizes the importance of the relationship between the preceding activity and the subsequent activity. This is because, in most cases, the process of completing a specific space and carrying out the finishing activity and the electrical installation activity is a serial relationship rather than a single activity, and these activities mutually influence each other.

The safety standard utilizes the conventional related laws and guidelines, but it is determined to be largely effective to introduce the concept of process management for additional safety accident prevention, analyze the influence between some activities in the time series, and limit the range of the influence to be set as the safety standard.

Comprehensively, the status of all activities on the site is grasped every day as much as possible at the lowest level through the schedule bar chart, and if the safety management standards are exceeded, the risk of safety accidents increases. Knowing the problem is of the utmost importance, and solutions can be established and acted upon with current technology.

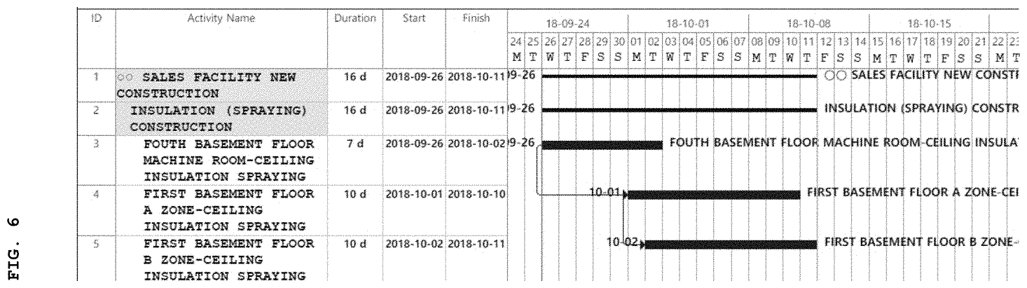

As a next step, FIGS. 6 to 8 illustrate the weekly schedule bar chart.

First, FIG. 6 is an example illustrating a schedule bar chart of a partner company performing the insulation activity according to the present invention. It is similar to the conventional schedule bar chart, and it can be prepared on the web of Excel or PMIS, and is prepared using a program specializing in preparing the schedule bar chart.

In the first column, the activity list to be constructed by the partner company during the previous week and this week, the second column is the number of activity days, the third column is the start date of the activity, and the fourth column is the completion date of the activity. In the right bar chart bar display area, bars are displayed according to the start and completion dates of the activity, so that the process progress can be easily understood visually.

When looking at the schedule bar chart, it illustrates that the activity of spraying polyurea foam on the ceiling is in progress in the machine room on the fourth basement floor and in Zone A on the first basement floor, and the activity starts in Zone B on the first basement floor on today.

Since the partner company knows where and what kind of activity the workers of his/her company are doing and gives the activity order, so that the schedule bar chart may be prepared with such contents.

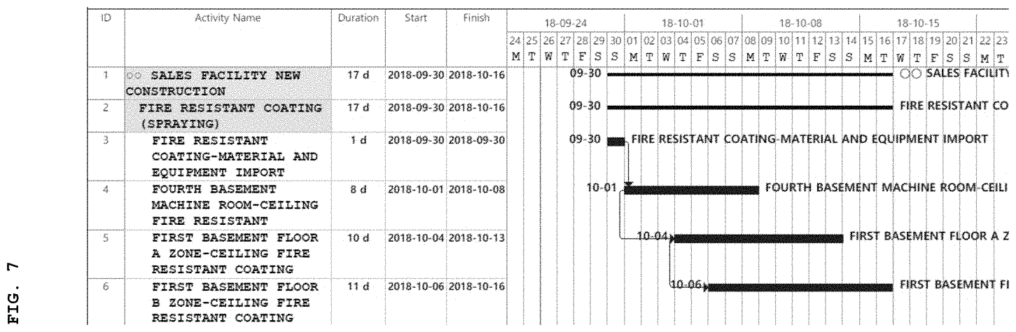

FIG. 7 is an example illustrating a schedule bar chart prepared by a partner company performing the fire resistant coating activity according to the present invention. When the spraying of the polyurea foam of FIG. 6 is performed, the activity of spraying the fire resistant coating of FIG. 7 on the polyurea foam follows. FIG. 6 is the current activity and FIG. 7 is the subsequent activity. As the distance between FIGS. 6 and 7 increases, the risk of fire increases.

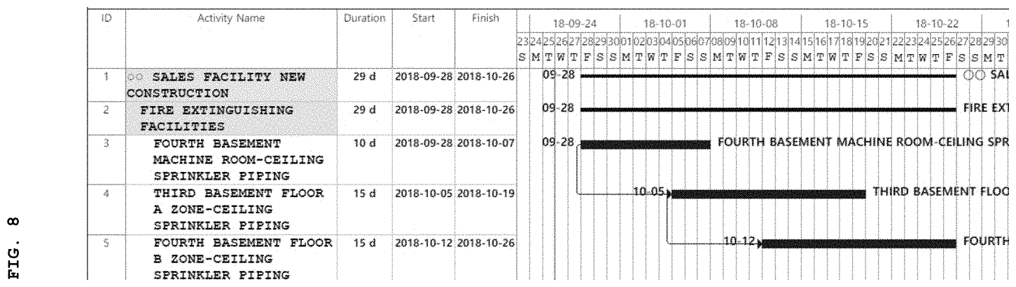

FIG. 8 is an example illustrating a schedule bar chart prepared by a partner company performing the fire extinguishing piping activity according to the present invention. It describes that the activity is in progress in the machine room on the fourth basement floor.

FIGS. 6, 7, and 8 illustrate examples of the schedule bar charts related to the machine room on the fourth basement floor among the schedule bar charts prepared by a number of partner companies as described above. It is necessary for the partner companies to prepare the schedule bar charts that their own companies are doing as illustrated in FIGS. 6 to 8.

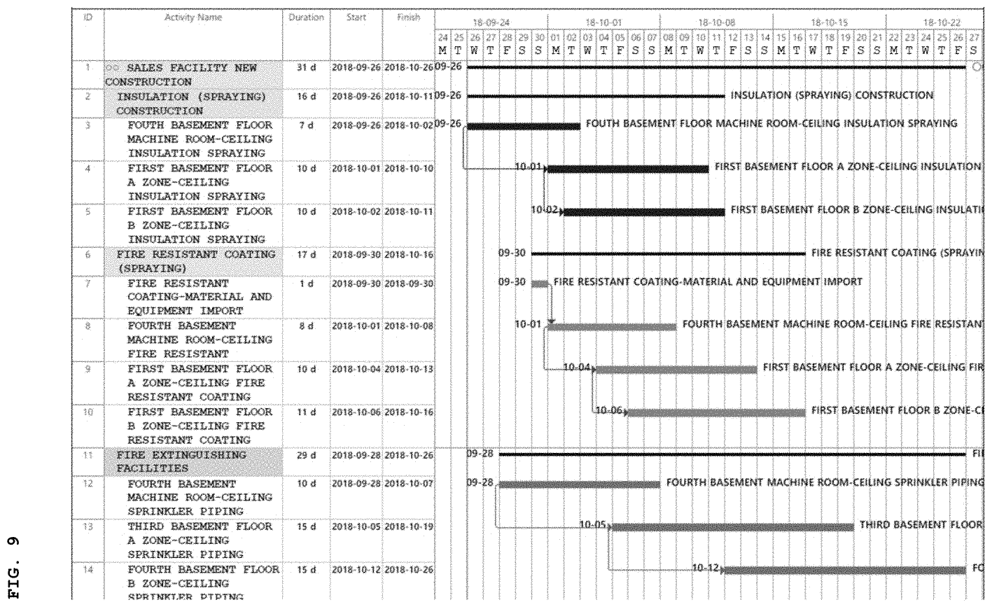

When each partner company prepares the schedule bar chart, the number of pages is large, so it is necessary for the original construction company to collect them in one place. In FIG. 9, the schedule bar charts prepared in FIGS. 6, 7, and 8 are integrated and displayed.

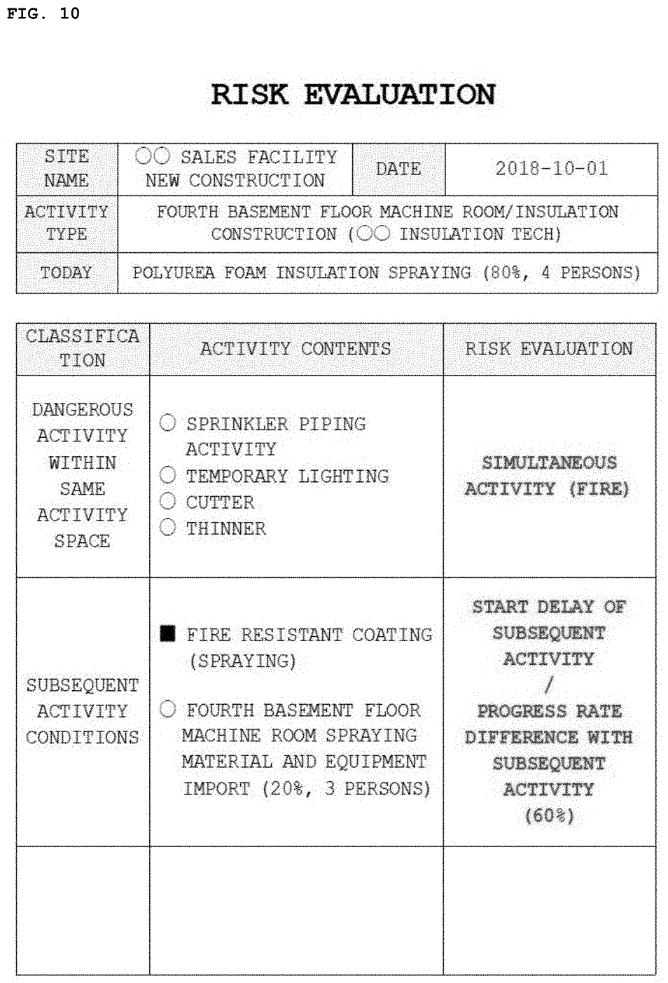

FIG. 10 is an example illustrating results of risk evaluation by analyzing the integrated schedule bar chart of FIG. 9. Polyurea foam spraying is started on September 27 and the activity is being completed, but the fire resistant coating construction for fire prevention is started late on October 1, thereby leaving the polyurea foam exposed to fire.

The control unit 21 determines whether the difference in schedule and the difference in progress rate exceeds the subsequent activity condition and displays the risk evaluation result. According to the evaluation contents, as of October 1, almost all of the polyurea foam spraying is performed at 80% on the ceiling of the machine room on the fourth basement floor, and on the indoor bottom of the same floor, the activity for cutting the pipe with a high-speed cutter and the activity for cleaning the pipe connecting parts with a thinner are performed for the installation activity of the facility sprinkler fire extinguishing pipe. In addition, the fire resistant coating construction is about to start now.

If the pipe is cut with the cutter, sparks fly, and the sparks stick to the thinner, it catches fire, and if the fire moves to the ceiling, most of the polyurea foam catches fire. This is because the subsequent process, that is, fire resistant coating spraying follows later.

Currently, the machine room is evaluated to have a very high risk of fire as several activities are being performed.

In the past, polyurea foam ignited in the basement and serious disasters caused by smoke have been reported in the news several times.

Although the cause of the accident is generally focused on the management of the cutter and the flame of the thinner, when looking at the examples of the assumption according to the present invention, if the cause of the accident is analyzed three-dimensionally in a time series not only for other activities in the space, but also the conditions of additional upper and lower activities, and the preceding and subsequent processes, the fire resistant coating that is the subsequent process is started late and followed later, and thereby it is also the cause of the failure to protect the polyurea foam from the flame through the fire resistant coating. If it was pointed out in advance that the start of the fire resistant coating would be delayed through the application of the present invention, the fire would not have occurred or the damage would not been large through the measures.

As described above, one example is given in this embodiment, but according to the present invention, it evaluates quickly and accurately various risks from major disasters to minor disasters exceeding safety standards systematically set in advance for the activity in all spaces on construction and industrial sites. Therefore, necessary measures can be taken, and as a result, safety accidents do not occur.

The schedule bar chart, safety standard, and safety evaluation databases can be used within the schedule bar chart preparation program itself by adding functions to Primavera and MS-Project which are commercial professional process management programs. If the conventional schedule bar chart preparation program was used only for schedule bar chart preparation, the safety management function is added to the program.

Since the schedule bar chart has all construction information, it is possible to quickly and accurately evaluate the risks.

Another method may be utilized by adding a database function related to safety to a Project Management Information System (PMIS) that is a project management portal of a construction company, preparing the schedule bar chart in Primavera, MS-Project or Excel file, which are specialized programs, and reading the file.

The schedule bar chart is displayed in a bar chart Kant chart with the activity name, start date, and completion date. The schedule bar chart in the present invention includes a document having information about a process or a construction schedule that contains information about what activity is and when the activity starts and when the activity ends.

### INDUSTRIAL APPLICABILITY

According to the present invention, it can be applied to various activities (civil engineering, construction, electricity, equipment, environment, plant) processing in all spaces on construction and various industrial sites (shipbuilding, automobiles, and the like). Construction companies create weekly schedule bar charts using PCs or smartphones. When the schedule bar chart is prepared, the control unit can comprehensively identify the activity environment of the activity place, the precedence relationship between activities, safety standards, and the like in real time, analyze the high-risk activity, and perform notification of the countermeasures. Therefore, it is possible to be used as a method of reducing safety accidents.

1. A safety information generation apparatus using a schedule bar chart in a risk evaluation using a schedule bar chart to prevent disaster on an industrial site, the apparatus comprising:
a schedule bar chart database that stores contents of a schedule bar chart;
a safety standard database that sets and stores a safety standard for an activity;
a control unit that determines a risk of the activity by comparing construction information of the schedule bar chart with the safety standard; and
a safety information database that stores a risk evaluation result of the activity determined by the control unit.

2. The safety information generation apparatus using a schedule bar chart according to claim 1, wherein the schedule bar chart includes information on an activity name, an activity position, a start time, or a completion time.

3. The safety information generation apparatus using a schedule bar chart according to claim 1, further comprising at least one of:
a schedule bar chart prepared by a commercial program for preparing a network schedule bar chart;
a schedule bar chart prepared by using a spreadsheet Excel; and
a schedule bar charts prepared on a PMIS.

4. The safety information generation apparatus using a schedule bar chart according to claim 1, wherein the safety standard includes one of an installation status of safety facilities that the activity must have, an environmental status of gas, temperature, humidity, and water, an activity order, a procedural status, conditions (start, completion, schedule difference, and progress rate) that the precedent activity must have, conditions (start, schedule difference, and progress rate) that the subsequent activity must have, and limiting conditions for the activity performed in up, down, left, and right spaces.

5. The safety information generation apparatus using a schedule bar chart according to claim 1,
wherein the safety standard sets a relationship between a parallel activity, a preceding activity, and a subsequent activity for a specific activity; and
wherein the relationship includes a standard related to one of the start, the completion, the schedule difference, and the progress rate difference.

6. The safety information generation apparatus using a schedule bar chart according to claim 1, wherein the safety standard further includes at least one of an activity classification system, an activity list in which activities are divided by floor, room, and system based on the activity classification system, a safety measure, and a countermeasuring method.

7. The safety information generation apparatus using a schedule bar chart according to claim 1,
wherein the control unit reads the information on the activity on the schedule bar chart and determines whether the information exceeds conditions set in the safety standard; and
determines a risk by performing at least one of
a comparison with a safety condition necessary for performing the relevant activity itself;
a comparison with a condition stipulating an influence of another construction type processed at the same time;
a comparison with a condition stipulating what state the preceding activity should be in; and
a comparison with a condition stipulating what state the subsequent activity should be in.

8. The safety information generation apparatus using a schedule bar chart according to claim 1, wherein the control unit evaluates the risk by comparing at least one of the start, the completion, the schedule difference, and the progress rate difference between a parallel activity, a preceding activity, and a subsequent activity for a specific activity.

9. A safety information generation method using a schedule bar chart in a risk evaluation method using a schedule bar chart to prevent disaster at an industrial site, the method comprising:
a step of preparing the schedule bar chart and storing the schedule bar chart in a schedule bar chart database;
a step of setting a safety standard for the activity and storing the safety standard in a safety standard database; and
a step of evaluating a risk by reading contents of the schedule bar chart and determining whether the activity contents exceeds the safety standard by a control unit.

10. The safety information generation method using a schedule bar chart according to claim 9, further comprising:
a step of preparing the schedule bar chart to include an activity name and a position and further include information on a start time or a completion time.

11. The safety information generation method using a schedule bar chart according to claim 9, wherein the safety standard is described by including at least one of
an installation status of safety facilities that the activity must have;
environmental statuses of gas, temperature, humidity, and water, an activity order, a procedural status;
conditions (start, completion, schedule difference, and progress rate) that the precedent activity must have; and
conditions (start, schedule difference, and progress rate) that the subsequent activity must have.

12. The safety information generation method using a schedule bar chart according to claim 9, further comprising:
a step of further describing at least one of an activity classification system, an activity list in which the activity is divided by floor, room, and system line based on the activity classification system, a safety measure, and a countermeasuring method in the safety standard.

13. The safety information generation method using a schedule bar chart according to claim 9, further comprising:
a step of determining a risk by reading a schedule bar chart of a partner company by date and performing by a control unit at least one of
a comparison with the conditions of the activity itself set in the safety standards for the relevant activity;
a comparison with a preceding activity condition;
a comparison with a subsequent activity condition;
a comparison with an activity type that should not be performed at the same time in an activity space; and
a comparison with at least one of conditions of the activities performed in upper, lower, left, and right spaces.

14. The safety information generation apparatus using a schedule bar chart according to claim 9, further comprising:
a step of evaluating a risk by determining at least one of a start, a completion, a schedule difference, and a progress rate difference between a parallel activity, a preceding activity, and a subsequent activity based on a risk evaluation target activity by a control unit.

15. A computer-readable recording medium on which the safety information generation method using a schedule bar chart according to claim 9 is recorded.
